(19) United States
(12) Patent Application Publication
(10) Pub. No.: US 2009/0226754 A1
(43) Pub. Date: Sep. 10, 2009

(54) THERMAL CONDUCTIVITY SHEET AND ELECTRONIC DEVICE

(75) Inventors: Jun Taniguchi, Kawasaki (JP); Minoru Ishinabe, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/469,109

(22) Filed: May 20, 2009

Related U.S. Application Data
(63) Continuation of application No. PCT/JP2006/323803, filed on Nov. 29, 2006.

(51) Int. Cl. B32B 15/00; B32B 7/02

(52) U.S. Cl. 428/615; 428/217

(57) ABSTRACT

There is provided a thermal conductivity sheet capable of lowering the thermal resistance value of the joint surface more than before in addition to easiness to use, and an electronic device to which the thermal conductivity sheet is applied. Load is applied to the thermal conductivity sheet having a prescribed thickness placed between CPU 10 that is the heat generation parts and the heat sink 11 that is the heat radiation parts. The thermal conductivity sheet has hardness wherein intervals between CPU 10 that is the heat generation parts and the heat sink 11 that is the heat radiation parts narrow more than the prescribed thickness by either of load within the range from 0.01 kgf/cm² to 5.0 kgf/cm² with tightening of screw.

### CROSS-REFERENCE TO RELATED APPLICATION

This is a continuation application of PCT/JP2006/323803, filed on Nov. 29, 2006.

### FIELD

The present invention relates to a thermal conductivity sheet, and an electronic device that includes the thermal conductivity sheet.

### BACKGROUND

Recently, as to the semiconductor element such as CPU, speeding up of the processing speed when operating in addition to the high integration advances, and there is a tendency that the calorific value more increases than so far. Therefore, if the heat generated when the semiconductor element operates is not efficiently radiated outside, there is a fear that an internal temperature of the semiconductor element exceeds the limit of the operating temperature while operating and as a result the semiconductor element will be damaged by a fire.

Under the present situation, there is adopted a method in which heat generated by a semiconductor element is transmitted to a heat sink and the transmitted heat is radiated from the heat sink to the outside. However, according to such a method, a direct coupling of the heat sink to the package of the semiconductor element brings about rising of the thermal resistance value on a joint surface where the package of the heat sink and the semiconductor element connects with one another by the ruggedness on the surface of the heat sink and the ruggedness of the package of the semiconductor element, and thus the heat generated by the semiconductor element cannot be transmitted even to the heat sink well.

Thus, there are adopted techniques of efficiently transmitting heat that generates on the semiconductor element to the heat sink with lowering the thermal resistance value on the joint surface by means of interposing a thermal conductivity of grease, a phase change sheet, or a heat conduction sheet between the surface of the package of the semiconductor element and the surface of the heat sink so as to make them become familiar with the ruggedness on both surfaces of the heat sink and the package of the semiconductor (For instance, refer to Japanese Patent document 1 to Japanese Patent document 6). When heat is efficiently transmitted from the semiconductor element to the heat sink in accordance with those techniques, the rise of an internal temperature of the semiconductor element is controlled so that certain operation of the semiconductor element is guaranteed.

Incidentally, though the use of the grease makes it possible to implement the low thermal resistance because the grease is high in liquidity, and becomes familiar well with the ruggedness on the surfaces of the package of the semiconductor and the heat sink, it is obliged to introduce instruments such as syringes and spreading machines in order that only the fixed quantity is spread on the surface of the heat sink and the surface of the package of the semiconductor. This involves the problem that handling becomes complex. The phase change sheet melts by the rise in heat under operation of the semiconductor element and becomes familiar with the ruggedness of surfaces on both the heat sink and the semiconductor element. Thus, it is possible to implement the low thermal resistance. However, when removing, heating is needed when installing it once. Therefore, in a similar fashion to the grease, this involves the problem that handling becomes complex.

To the contrary, the thermal conductivity sheet never has liquidity like the grease and the heated phase change sheet, and it is sufficient that the sheet with prescribed hardness, which is built in a prescribed thickness, is interposed between the heat sink and the package of the semiconductor element, and it is simply tighten with the screw and the like to be installed. Therefore, the thermal conductivity sheet has the advantage of being easy in detaching and easily very treating.

However, a conventional thermal conductivity sheet has the fault that the thermal resistance value of the bonded surface cannot be lowered a little without becoming familiar with a ruggedness of surfaces on both heat generation parts and the heat radiation parts, because it has prescribed hardness.

### SUMMARY

Accordingly, it is an object in one aspect of the invention to provide a thermal conductivity sheet that is interposed between heat generation parts and heat radiation parts where the heat of the heat generation parts is transmitted to the heat radiation parts, wherein when load is applied to the thermal conductivity sheet having a prescribed thickness placed between the heat generation parts and the heat radiation parts, the thermal conductivity sheet has hardness wherein intervals between the heat generation parts and the heat radiation parts narrow more than the prescribed thickness by either of load within the range from 0.01 kgf/cm² to 5.0 kgf/cm².

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an explanatory view useful for understanding the difference of the states where a conventional thermal conductivity sheet 2 and a thermal conductivity sheet 1 that is one embodiment of the present invention are interposed between CPU 10 that is heat generation parts and a heat sink 11 that is heat radiation parts;

FIG. 2 is a view useful for understanding the state before a thermal conductivity sheet is interposed between CPU and a heat sink; and

FIG. 3 is a view useful for understanding a structure of a personal computer in which a thermal conductivity sheet of the present invention is applied between CPU in a main unit and heat radiation parts.

### DESCRIPTION OF EMBODIMENTS

Hereinafter there will be explained embodiments of the present invention in conjunction with the drawings.

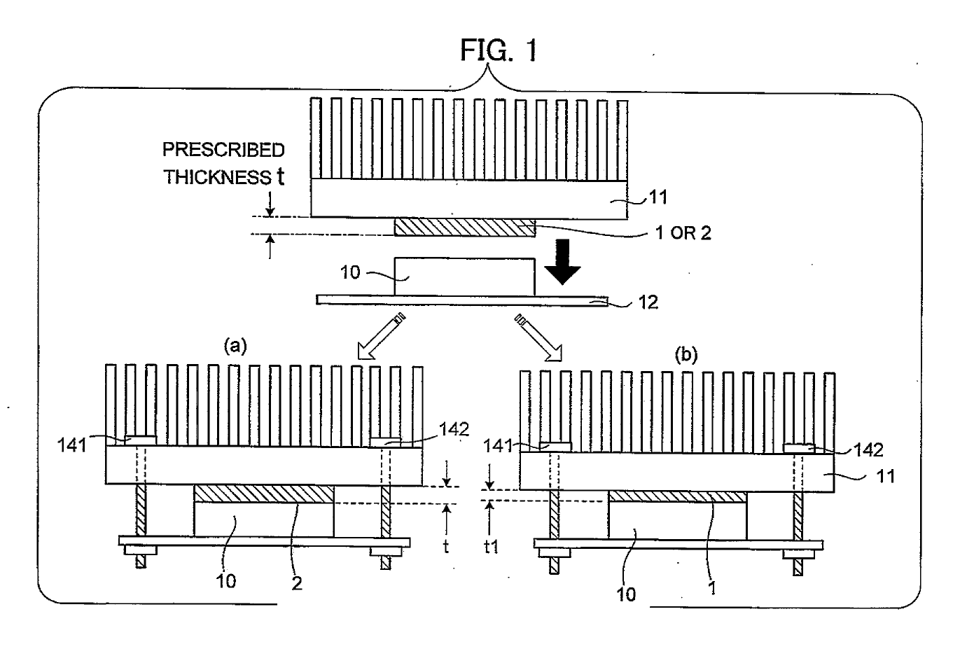

FIG. 1 is an explanatory view useful for understanding the difference of the states where a conventional thermal conductivity sheet 2 and a thermal conductivity sheet 1 that is one embodiment of the present invention are interposed between CPU 10 that is an example of heat generation parts referred to in the present invention and a heat sink 11 that is an example of heat radiation parts referred to in the present invention.

At the upper side of FIG. 1, there is illustrated the state before some thermal conductivity sheet is interposed between CPU 10 and a heat sink 11. At the left of the lower side of FIG. 1, there is illustrated the state after the conventional thermal conductivity sheet 2 is put. At the right of the lower side of FIG. 1, there is illustrated the state after the thermal conductivity sheet 1 of the present invention is put. At the lower side of FIG. 1, there is depicted the figure in which the state where the thermal conductivity sheet 1 or 2 is put between CPU 10 and the heat sink 11 and tightening screws is cut so as to cross both screws, and it is viewed from the front.

According to the present embodiment, when tightening with screws 141 and 142 after the thermal conductivity sheet 1 of the present invention is interposed between the heat sink 11 and CPU 10 and installing it on a substrate 2, there is defined as a load in the limit the load (5.0 kgf/cm² here) that the joint part of the substrate 12 and CPU 10 breaks. The reason why this is to do so is that applying the load 5.0 kgf/cm² or more brings about too much growth of load to be applied to the joint part of CPU 10 and the substrate 12, for instance, BGA (Ball Grid Array) and the joint part of CPU 10 and substrate 12 breaks.

Moreover, the load applied to the thermal conductivity sheet 1 by one's own weight of the heat sink 11 used here is 0.01 kgf/cm² or less, and the thermal conductivity sheet 1 of the present invention has hardness that the interval between the heat sink 11 and CPU 10 narrows by some load within the range of the load from 0.01 kgf/cm² to 5.0 kgf/cm² by tightening the screws 141 and 142.

Now there will be explained the feature of the thermal conductivity sheet 1 of the present invention while comparing the conventional thermal conductivity sheet 2 and the thermal conductivity sheet 1 of the present invention referring to FIG. 1(a) at the left of the lower side of FIG. 1 and FIG. 1(b) at the right of the lower side of FIG. 1.

To assume that the conventional thermal conductivity sheet 2 is the one to which the load of 0.01 kgf/cm²-5.0 kgf/cm² is applied too, and that both the thermal conductivity sheets have prescribed thickness t, there will be explained.

As for the conventional thermal conductivity sheet 2 illustrated at the left of the lower side of FIG. 1, as mentioned above, it has prescribed hardness. Therefore, the interval between the heat sink 11 and CPU 10 doesn't change so much like prescribed thickness t or an interval any more even if the load of 0.01 kgf/cm² that exceeds one's own weight of the heat sink 11 is applied. Moreover, even if the screws 141 and 142 are tightened to apply the maximum load 5.0 kgf/cm², the interval between the heat sink 11 and CPU 10 doesn't become the interval of less than prescribed thickness t. This indicates, as mentioned above, that when the conventional thermal conductivity sheet 2 is put between CPU 10 and the heat sink 11, the thermal conductivity sheet 2 undulates somewhat by the ruggedness and undulations on the surface of CPU 10 and the heat sink 11, and as a result, the interval between CPU 10 and the heat sink 11 becomes prescribed thickness t or more, so that the interval between CPU 10 and the heat sink 11 becomes only prescribed thickness t of the thermal conductivity sheet 2 even if the screws 141 and 142 are tightened further.

On the other hand, as for the heat conduction sheet 1 of the present invention of the lower side of FIG. 1, when it is interposed between CPU 10 and the heat sink 11, the screws 141 and 142 is tightened, and the load is applied, the interval between CPU 10 and the heat sink 11 narrows more than prescribed thickness t and becomes thickness t1.

In a word, the thermal conductivity sheet 1 of the present invention has hardness herein the interval between the heat sink 11 and CPU 10 narrows by either of load between the load of 0.01 kgf/cm² defined by one's own weight of the heat sink 11 and the load of 5.0 kgf/cm² defined by the maximum load to be applied to the joint part.

Here, it easily first explains the composition of the thermal conductivity sheet 1 of the present invention before it explains the hardness that the thermal conductivity sheet 1 of the present invention has.

As for the thermal conductivity sheet 1 of the present invention, the fatty acid ester (H-381R: product name of Nippon Oils And Fats Ltd.) is used for the resin that becomes basic, and inorganic filler that consists of the zinc oxide is used for the thermal conductivity filler. In addition, two kinds of inorganic fillers (filler 1 average particle size: 11 μm, filler 2 average particle size: 0.75 μm), which are different in particle size, are used for the inorganic filler that consists of the zinc oxide. Incidentally, though the zinc oxide is used here, it is acceptable that inorganic fillers such as the aluminum nitride, the boron nitride, and alumina and silica, are used, and it is also acceptable that metallic fillers such as gold, silver, copper, and aluminum, are used. Moreover, according to this example, the fine thermal conductivity filler as mentioned above is used. However, any one is acceptable, as the thermal conductivity filler, which has the average particle size from 0.5 μm to 50 μm and has the maximum particle size of less than 100 μm, since it is ideal that the thickness of the sheet is empirically about 100 μm in view of the performance and easiness to use.

The thermal conductivity sheet 1 of the present embodiment is made in such a manner that two kinds of filler 1 and fillers 2 that the above-mentioned resin is made a base material and the above-mentioned particle sizes are mutually different are compounded and mixed in accordance with the integral blend method. Mixture of the filler by the integral blend may bring about uniform distribution of the thermal conductivity filler in the resin, and thus it is possible to obtain a steady thermal resistance value throughout the thermal conductivity sheet in its entire.

The above is an explanation of a composition of the thermal conductivity sheet 1 of the present invention.

Next, there will be explained as to whether the thermal resistance value can be lowered when the thermal conductivity sheet 1 with the above-mentioned composition is made the thermal conductivity sheet of what hardness, they are made to become familiar with the ruggedness on the surface of the package of CPU 10 and the ruggedness on the surface of heat sink 11.

Table 1 indicates the experimental result wherein the thermal resistance value where three kinds of thermal conductivity sheets A, B, and C with mutually different hardness present is measured on each load. Table 1 also indicates consistency of commercial item D to compare those thermal conductivity sheets A, B, and C with a conventional thermal conductivity sheet.

TABLE 1

| | | | MOUNTING | MOUNTING | MOUNTING |
|---|---|---|---|---|---|
| | | | LOAD (1.0 kgf/cm²) | LOAD (2.0 kgf/cm²) | LOAD (4.0 kgf/cm²) |
| | FILLER | | THERMAL | THERMAL | THERMAL |
| | AMOUNT (AT | | RESISTANCE | RESISTANCE | RESISTANCE |
| No. | RESIN 100) | CONSISTENCY | (° C. · cm²/W) | (° C. · cm²/W) | (° C. · cm²/W) |
| A | 1900 | 240 | 0.15 | 0.09 | 0.03 |
| B | 2100 | 190 | 0.17 | 0.13 | 0.1 |
| C | 2750 | 160 | 0.18 | 0.14 | 0.14 |
| D | COMMERCIAL | 145 | 0.25 | 0.18 | 0.16 |
| | ITEM D | | | | |

In Table 1, there is used consistency which is defined with JIS-K-2220 as a unit that represents the hardness of the thermal conductivity sheet A, B, C, and D. The value of consistency uses the conversion value to 1/1 corn (the support stick and total weight 150 g of corn).

Table 1 indicates with consistency the difference of hardness of the thermal conductivity filler where it is assumed that the compounding ratio of two kinds of inorganic fillers 1 and 2 is given by 7:3, and the thermal conductivity fillers of three kinds of amounts of 1900, 2100, and 2750 by the unit of the weight part assuming the resin to be 100 weight part are filled to the resin that is the base material, and then mixed in accordance with the integral blend method, so that the thermal conductivity sheet is made. When the thermal conductivity sheet when the result of depicted in Table 1 is obtained is made, the part is mixed with the titanate system coupling medicine (KR-TTS: product name of Ajinomoto fine techno Ltd.) by one weight as a coupling medicine so that thermal conductivity filler may raise the filling of inorganic filler.

The more the amount of the thermal conductivity filler decreases, the more hardness becomes soft, and the more the amount of the thermal conductivity filler increases, the more hardness becomes hard. What indicates the hardness of the thermal conductivity sheet is the consistency. In a word, when the consistency grows, it will become soft.

In the commercial item that is the conventional thermal conductivity sheet depicted in Table 1, it is not possible to make the thermal conductivity sheet become familiar with the ruggedness of surfaces on both CPU 10 and the heat sink 11 well even if the load of 4.0 kgf/cm² is applied for instance because it has hard hardness named consistency 145, and thus the thermal resistance value is not able to be lowered. Table 1 indicates the thermal resistance value of individual load. In the conventional thermal conductivity sheet, it becomes the thermal resistance value of 0.25° C.·cm²/W with load 1 kgf/cm², becomes 0.18° C.·cm²/W with 2 kg, and becomes 0.16° C.·cm²/W with 4 kg. This is caused by the reason that when the thermal conductivity sheet of prescribed thickness t is put as mentioned above between CPU 10 and the heat sink 11, the interval between CPU 10 and the heat sink 11 becomes prescribed thickness t or more due to the ruggedness and the undulation of the surfaces of CPU 10 and the heat sink 11, and thus it is simply possible to make the interval between CPU 10 and the heat sink 11 become familiar only with prescribed thickness t even if tightening up a screw. In a word, since prescribed hardness is possessed, thermal conductivity sheet 2 cannot be made the thickness of less than prescribed thickness t in the past.

Then, according to the present embodiment, it is intended to offer the thermal conductivity sheet with a thermal resistance value that is lower than conventional thermal conductivity sheet 2 by softening thermal conductivity sheet through raising the value of consistency like 160, 190, and 240.

Table 1 indicates that there is obtained the low thermal resistance value such as 0.18-0.14° C.·cm²/W with consistency 160, 0.17-0.1° C.·cm²/W with consistency 180, and 0.15-0.03° C.·cm²/W with consistency 240.

Thus, when the consistency which is the standard of hardness is 160 to 240, it becomes a thermal conductivity sheet where it excels in the handling character and an excellent thermal resistance value is indicated.

Here, Table 2 indicates the result where the load of 1.0-5.0 kgf/cm² is applied to the thermal conductivity sheet of consistency of 160 or less and individual hardness is confirmed. Table 2 indicates the relation between consistency and hardness.

TABLE 2

CONSISTENCY

| LOAD(kgf/cm²) | 130 | 140 | 150 | 160 |
|---|---|---|---|---|
| 1.0 | 1.00 | 1.00 | 1.00 | 1.00 |
| 2.0 | 1.00 | 1.00 | 1.00 | 0.96 |
| 3.0 | 1.00 | 1.00 | 0.96 | 0.95 |
| 4.0 | 1.00 | 1.00 | 0.95 | 0.93 |
| 5.0 | 1.00 | 1.00 | 0.93 | 0.90 |

1.00 AT LOAD 1.0 kgf/cm²

Table 2 indicates how the interval between the heat sink 11 and CPU 10 narrows when the load of 1.0-5.0 kgf/cm² is applied to thermal conductivity sheets which are of consistencies 130, 140, 150, and 160, respectively, where individual thermal conductivity sheet is put between the heat sink 11 and CPU 10. Table 2 indicates in the ratio how the interval narrows every consistency when load 2 kgf/cm², 3 kgf/cm², 4 kgf/cm², and 5 kgf/cm² are sequentially applied assuming that the interval is one when load 1 kgf/cm² is applied.

As understood from Table 2, the interval between the heat sink 11 and CPU 10 doesn't narrow in thermal conductivity sheets which are of consistency 130 and 140 even in case of which load. It is guessed that the conventional thermal conductivity sheet offers behavior that is the same as the thermal conductivity sheet of consistency 145.

To the contrary, it would be understood that in the thermal conductivity sheet of consistency 150, intervals between the heat sink 11 and CPU 10 narrow like 0.96, 0.95, and 0.93 in the ratio when the load becomes 3.0 kgf/cm² or more, and in the thermal conductivity sheet of consistency 160, intervals between the heat sink 11 and CPU 10 narrow like 0.96, 0.95, 0.93, 0.90 in the ratio when the load becomes 2.0 kgf/cm² or more.

From these it would be understood that the use of a thermal conductivity sheet of consistency 150 or more makes it possible to lower the thermal resistance value in accordance with application of a suitable load.

In a word, it is effective that consistency is 150 or more when the thermal conductivity sheet where the thermal resistance value can be lowered is made.

Incidentally, when the thermal conductivity sheet is put between CPU 10 and the heat sink 11, it is not the thermal conductivity filler but a resin that becomes familiar with the ruggedness on both surfaces of CPU 10 and the heat sink 11. Therefore, it is necessary to give the resin some viscosity. Filling the thermal conductivity filler to the resin that gives the viscosity makes it possible to narrow the interval between the heat sink 11 and CPU 10 even the maximum diameter of the thermal conductivity filler. In this example, the viscosity from 5 m Pas to 1500 m Pas is given to the resin.

The consistency, that is the unit of hardness adopted in the present embodiment, is controlled by the viscosity of the resin and the amount of filling of the filler. When the amount of filling of the filler is decreased, the consistency becomes large to be soft, and oppositely when the amount of filling of the filler is increased, the consistency becomes small to be hard.

A prescribed thickness, here 100 μm, of sheet might not be able to be built when the resin that has the viscosity from 5 m Pas to 1500 m Pas is built like the sheet in any where the amount of filling of the thermal conductivity filler is increased too much or it is decreased too much.

Table 3 indicates the result whether consistency 130-280 is able to be built in the sheet of a prescribed thickness.

TABLE 3

| | CONSISTENCY | | | | | | | |
|---|---|---|---|---|---|---|---|---|
| | 130 | 140 | 150 | 160 | 190 | 240 | 270 | 280 |
| EX- | NG*1 | OK | OK | OK | OK | OK | OK | OK*2 |
| TERIOR | | | | | | | | |
| OF | | | | | | | | |
| SHEET | | | | | | | | |

*1Not be able to be formed in 100 μm
*2Can not maintain geometry

As seen from Table 3, when consistency is 130, the amount of filling of the filler is too large, so that the control of the thickness is not made good at the time of building, and thus the sheet cannot be built in a prescribed thickness. Further, as seen from Table 3, when consistency is 280, the amount of filling of the filler is a too little, so that it becomes soft too much, and it is not possible to build in the sheet. From these, it would be understood that it is possible to obtain the thermal conductivity sheet where the effect of lowering the thermal resistance value is demonstrated in case of consistency 150 to 270.

In other words, in order to obtain the thermal conductivity sheet where the thermal resistance value can be lowered by either of loads within the range of the load of 0.01 kgf/cm²-5.0 kgf/cm² being added, it is effective that consistency is controlled between 150-270. Further if consistency can be narrowed from the range 150-270 to 160-240, it is possible to obtain the thermal conductivity sheet where it excels in the handling character and the thermal resistance value is installed on the value within the prescribed range.

Finally, it will be explained as to how the thermal conductivity sheet 1 that has hardness that the interval between CPU 10 and the heat sink 11 narrows with the load of 0.01 kgf/cm²-5.0 kgf/cm² where consistency is thus controlled is very easily treated.

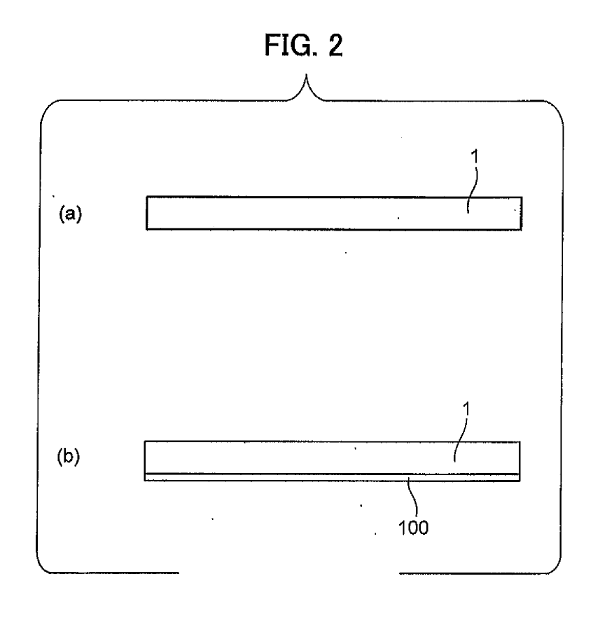

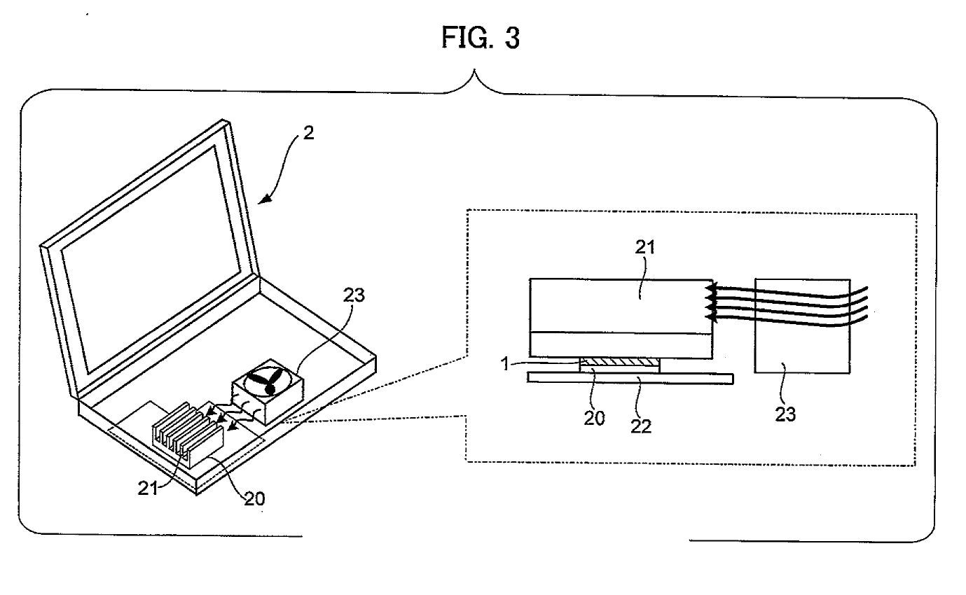

FIG. 2 is a view useful for understanding the state before the thermal conductivity sheet 1 is interposed between CPU and the heat sink. FIG. 3 is a view useful for understanding a structure of a personal computer in which the thermal conductivity sheet 1 is interposed between CPU 20 and the heat sink 21 so as to make to radiate heat efficiently.

The thermal conductivity sheet 1 depicted in FIG. 2 is formed on a metallic foil 100 before the use. The metallic foil 100 has a structure that is excellent in handling character by strength of the sheet itself and detachability of CPU. It is desirable that the metallic foil is materials of aluminum, copper, silver, and gold etc.

When the thermal conductivity sheet 1 is put on CPU 20 in the electronic device, for instance, the personal computer, and the heat sink 21 is put thereon and stopped with a screw as explained in FIG. 1, the thermal conductivity sheet 1 is built easily then in the personal computer 2. A cooling effect more than before is demonstrated only by adjusting the tightening condition of the screw stop to make a load within the range 0.01 kgf/cm²-5.0 kgf/cm², and doing the thermal conductivity sheet 1 in the mount.

FIG. 3 indicates the example wherein ventilation is done from a fan 23 in the personal computer 2 aiming at the heat sink 21 and CPU 20 is cooled by the compulsion air cooling method.

As indicated in the enlarged view at the right of FIG. 3, CPU 20 is cooled in such a way that the heat that is transmitted from CPU 20 on a substrate 22 through the thermal conductivity sheet 1 to the heat sink 21 is cooled by ventilation from the fan 23. At that time, the thermal resistance value on the joint surface between the heat sink 21 and CPU 20 is lowered with the thermal conductivity sheet 1 of the present invention, and thus a lot of heat in the unit time is transmitted even to the heat sink 21 as compared with the conventional one, so that heat is radiated from the heat sink 21. Therefore, CPU 20 is effectively cooled and certain operation of CPU 20 is guaranteed.

As explained above, it is possible to implement a thermal conductivity sheet capable of lowering the thermal resistance value of the joint surface more than before in addition to easiness to use, and an electronic device to which the thermal conductivity sheet is applied.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A thermal conductivity sheet that is interposed between heat generation parts and heat radiation parts where the heat of the heat generation parts is transmitted to the heat radiation parts, wherein:
when load is applied to the thermal conductivity sheet having a prescribed thickness placed between the heat generation parts and the heat radiation parts, the thermal conductivity sheet has hardness wherein intervals between the heat generation parts and the heat radiation parts narrow more than the prescribed thickness by either of load within the range from 0.01 kgf/cm² to 5.0 kgf/cm².

2. The thermal conductivity sheet according to claim 1, wherein the thermal conductivity sheet has consistency of 150-270.

3. The thermal conductivity sheet according to claim 1, wherein the thermal conductivity sheet has consistency of 160-240.

4. The thermal conductivity sheet according to claim 1, wherein the thermal conductivity sheet is formed on a metallic foil.

5. The thermal conductivity sheet according to claim 1, wherein the thermal conductivity sheet is one in which a thermal conductivity filler is distributed in a resin.

6. The thermal conductivity sheet according to claim 5, wherein the thermal conductivity filler is metallic filler.

7. The thermal conductivity sheet according to claim 5, wherein the thermal conductivity filler is inorganic filler.

8. The thermal conductivity sheet according to claim 5, wherein the thermal conductivity filler has an average particle size from 0.5 μm to 50 μm, has a maximum particle size of less than 100 μm, and includes two or more fillers with mutually different average particle size.

9. The thermal conductivity sheet according to claim 1, wherein the thermal conductivity sheet includes a resin of viscosity from 5 mPas to 1500 mPas.

10. An electronic device comprises: electronic parts that generate heat, heat radiation parts that radiate the heat of the electronic parts, and a thermal conductivity sheet that is interposed between heat electronic parts and the heat radiation parts where the heat of the electronic parts is transmitted to the heat radiation parts,
wherein when load is applied to the thermal conductivity sheet having a prescribed thickness placed between the electronic parts and the heat radiation parts, the thermal conductivity sheet has hardness wherein intervals between the electronic parts and the heat radiation parts narrow more than the prescribed thickness by either of load within the range from 0.01 kgf/cm² to 5.0 kgf/cm².
